(19) United States
(12) Patent Application Publication
(10) Pub. No.: US 2008/0112527 A1
(43) Pub. Date: May 15, 2008

(54) Apparatus and method for ignition of high-gain thermonuclear microexplosions with electric-pulse power

(75) Inventor: Friedwardt M. Winterberg, Reno, NV (US)

Correspondence Address: KLARQUIST SPARKMAN, LLP, 121 SW SALMON STREET, SUITE 1600, PORTLAND, OR, 97204, US

(73) Assignee: Board of Regents of the University and Community College System of Nevada

(21) Appl. No.: 11/647,545

(22) Filed: Dec. 27, 2006

Related U.S. Application Data
(63) Continuation of application No. 10/831,538, filed on Apr. 22, 2004, now abandoned.
(60) Provisional application No. 60/465,489, filed on Apr. 24, 2003.
(60) Provisional application No. 60/527,187, filed on Dec. 4, 2003.

(51) Int. Cl. H05H 1/22; G21B 1/00

(52) U.S. Cl. 376/100

(57) ABSTRACT

An apparatus for generating thermonuclear microexplosions includes a first pulsed high-voltage source configured for transmission of a first high-voltage pulse at a first high current. A second pulsed high voltage source is configured for transmission of a second high-voltage pulse at a potential higher than that of the first high-voltage pulse at a second high current having a magnitude less than that of the first high current. An inner transmission line is in electrical contact with the first pulsed high-voltage source, the inner line having a tapered end. An outer transmission line is disposed over the inner line and in electrical contact with the first pulsed high-voltage source. A deuterium-tritium mixture is disposed between the inner transmission line and the outer transmission line, the deuterium-tritium mixture having a tapered end spaced apart from the tapered end of said inner transmission line.

### CROSS-REFERENCE TO RELATED APPLICATIONS

This application claims priority from U.S. Provisional Patent Application Ser. No. 60/465,489, filed Apr. 24, 2003 and U.S. Provisional Patent Application Ser. No. 60/527,187, filed Dec. 4, 2003.

### BACKGROUND

The ultimate goal of controlled nuclear fusion by inertial confinement is a low-yield high-gain thermonuclear microexplosion, a low-yield required for the confinement of the microexplosion in a reactor vessel of manageable size, and a high gain for economy. To reach this goal the efficiency of the “driver” should be as high as possible, because the lesser the efficiency the higher the required gain. With their low efficiency this puts a heavy burden on lasers as drivers for thermonuclear microexplosions, requiring gains as large as 10³ to make up for the poor efficiency. Fast ignition schemes [1] requiring petawatt lasers can conceivably reduce the input energy for ignition, but with an energy larger than 100 kJ according to recent estimates, and the still smaller efficiency of petawatt lasers, not much is gained.

About 35 years ago it had been shown that the ignition of a thermonuclear microexplosion should be possible with an intense relativistic electron beam bombarding in less than 10⁻⁸ sec a less than cm-size solid deuterium-tritium (DT) target placed in a hollowed out anode also acting as a tamp. It was found that breakeven would be reached with a 10⁸ A, 10⁷ V electron beam drawing its energy from a 10 MJ Marx generator. At present efforts are under way to deliver the ignition energy indirectly, by first imploding a thin wire array, with the black body radiation released upon the mutual impact of the wires to implode a spherical target in much the same way as in indirect drive laser fusion schemes. As in impact fusion, substantial pulse power compression is here achieved by first accelerating the wires on a time scale large compared to the time in which they deliver an intense burst of black body radiation upon their mutual impact.

In a recent communication it has been shown that large gains with input energies conceivably as small as ˜10⁵ J can be reached with two much smaller Marx generators, one with a high current lower voltage for compression and confinement, and one with a high voltage lower current for ignition. This concept and its application for the controlled release of nuclear energy is here analyzed in greater detail.

### BRIEF DESCRIPTION

An apparatus for generating thermonuclear microexplosions includes a first pulsed high-voltage source configured for transmission of a first high-voltage pulse at a first high current. A second pulsed high voltage source is configured for transmission of a second high-voltage pulse at a potential less than that of the first high-voltage pulse at a second high current having a magnitude more than that of the first high current. An inner transmission line is in electrical contact with the first pulsed high-voltage source, the inner line having a tapered end. An outer transmission line is disposed over the inner line and is in electrical contact with the second pulsed high-voltage source. A deuterium-tritium mixture is disposed between the inner transmission line and the outer transmission line, the deuterium-tritium mixture having a tapered end spaced apart from the tapered end of said inner transmission line.

### BRIEF DESCRIPTION OF THE DRAWING FIGURES

FIG. 1 is a diagram showing two nested magnetically insulated transmission lines with the DT target ignited in the focus of both lines.

FIG. 2 is a diagram showing ignition of a thermonuclear burn wave inside a DT containing liner.

FIG. 3 is a diagram showing reactor configuration with DT containing liner placed in the center of the core of a liquid lithium vortex.

FIG. 4 is a diagram showing a circular stripline configuration.

FIG. 5 is a diagram showing a circular stripline configuration for rocket propulsion, with plasma jet J and magnetic reflector R. The DT fuel ignites the D with additional energy in the U blanket released by nuclear fission.

FIG. 6 is a diagram showing a convoluted high current feed for the outer transmission line positioned below the inner high voltage transmission line with liquid lithium vortex in the center.

FIG. 7 is a diagram showing beam focusing by use of a magnetic mirror.

FIG. 8 is a diagram showing a corrugated helical liner surface for axial and rotational shear flow stabilization.

FIG. 9 is a diagram showing fusion-fission target configuration and a relativistic electron beam.

FIG. 10 is a diagram showing a portion of an apparatus like that of FIG. 1, but including an axial bore through the first transmission line through which a laser beam may be directed through the apex of the conical end of the first transmission line to the tip of the DT cone to create an ionization trail to guide the electron beam from the cathode to the tip of the DT target.

FIG. 11 is a diagram illustrating a variation of the inner transmission line including a spiral groove formed on the inner conductor of the outer transmission line to increase the breakdown voltage of the inner transmission line by magnetic insulation.

Referring now to FIG. 12, a diagram shows another variation of the present invention in which the inner conductor of the outer transmission line is formed in a cylindrical shape, an outer wall is formed around the inner conductor of the outer transmission line, and a plasma is excited between the outer wall and the outer conductor to induce a large current as in a plasma focus configuration.

### DETAILED DESCRIPTION

Those of ordinary skill in the art will realize that the following description of the present invention is illustrative only and not in any way limiting. Other embodiments of the invention will readily suggest themselves to such skilled persons.

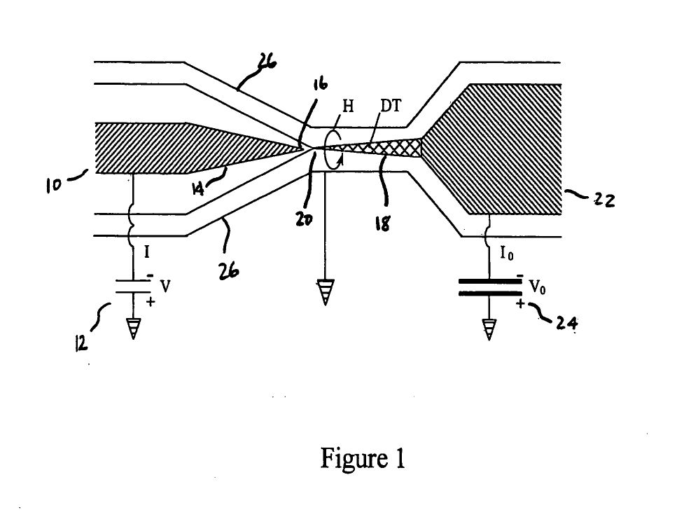

The basic principle of the concept can be explained for the special configuration of two nested magnetically insulated transmission lines as shown in FIG. 1. An inner transmission line 10 is coupled to a first high-voltage high-current pulse source 12, such as a Marx generator. The inner transmission line 10 ends in a cone 14 with the tip 16 of the cone serving as a cathode for a field emitted intense relativistic electron beam. The return current conductor of the inner transmission line 10 is at its smaller diameter connected to a cone of solid DT 18, serving as the anode of the inner transmission line 10, transmitting a pulse of voltage V and current I.

An intense relativistic electron beam emitted from the cathode tip 16 of the inner line is by selfmagnetic forces focused onto the DT cone 18, heating the tip 20 of the cone to thermonuclear temperatures. This follows the large electric current I₀ discharged from the second high-voltage high-current pulse source 24, such as a Marx generator, through the outer transmission line 22 at the voltage V₀, with the current passing over the DT cone 18, and the inner surface of the outer conductor 26 of the inner transmission line. This current must be large enough to generate at the focus of both transmission lines, a magnetic pressure which can balance the pressure of the DT plasma at thermonuclear temperatures. In the example of FIG. 1, for the inner transmission line a voltage of V=10⁷ V and a current of I=3×10⁵ A have been chosen, and for the outer transmission line a voltage of V=10⁶ V and a current of I=10⁷ A have been chosen.

In addition to heating the DT plasma, the energy from the relativistic electron beam emitted from the end of the inner transmission line 10 must compensate the axial expansion losses of the hot plasma blown off to the left from the tip 20 of the DT cone 18. If both conditions are met, a shockwave moves to the right into the DT cone 18, and if the charged fusion reaction α-particles are confined within the cone by the magnetic field of the current flowing over the cone (shown as field line H), the shock wave goes over into a thermonuclear detonation. wave supersonically moving down the cone 18. Except for the small region near the tip 20 of the cone 18, no magnetic plasma confinement is required, with the magnetic field H serving only to entrap the charged fusion reaction α-particles in the DT cone. Large fusion gains can therefore here be reached.

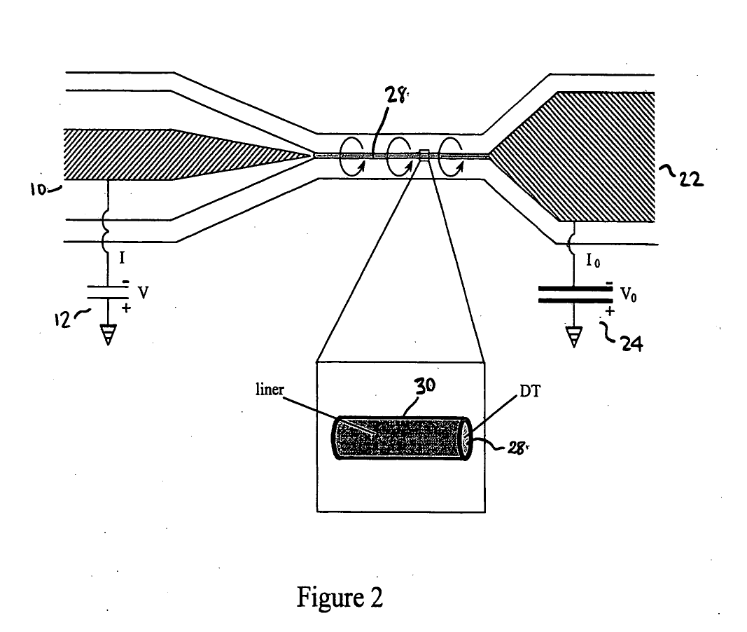

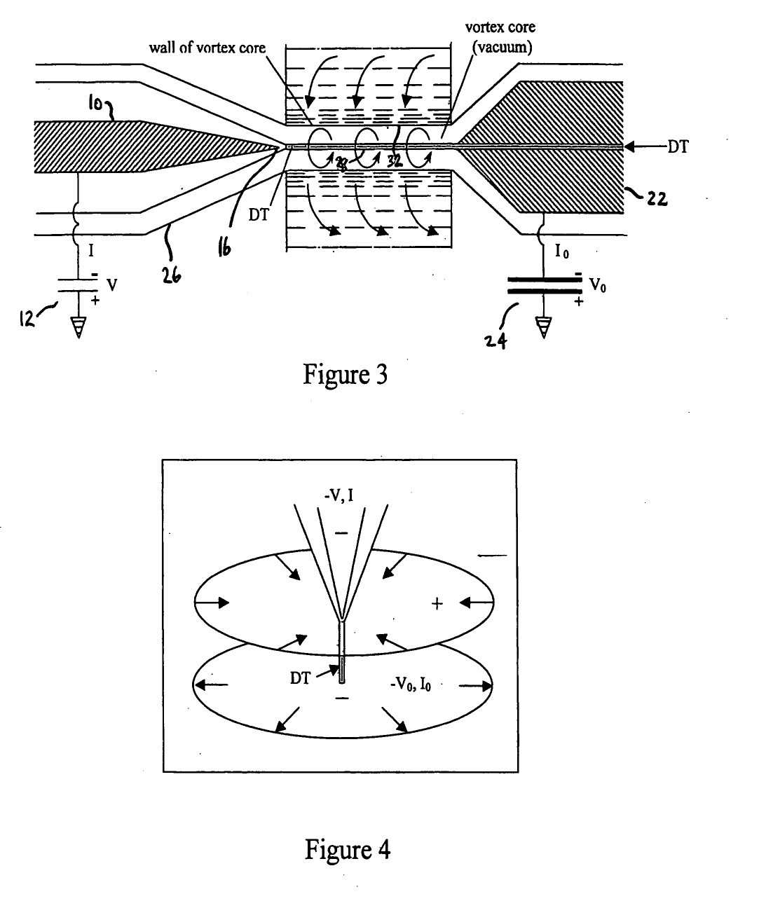

Instead of a short DT cone 18 one may take a long thin DT cylinder 28 placed inside a metallic liner 30 as shown in FIG. 2. If, as shown in FIG. 3, the return current conductor of the liner is the inner wall of a vortex tube 32 in liquid lithium, one arrives at a suitable thermonuclear reactor configuration where the 80% of the DT fusion reaction energy released in fast neutrons is dissipated in the lithium vortex, at the same time breeding tritium.

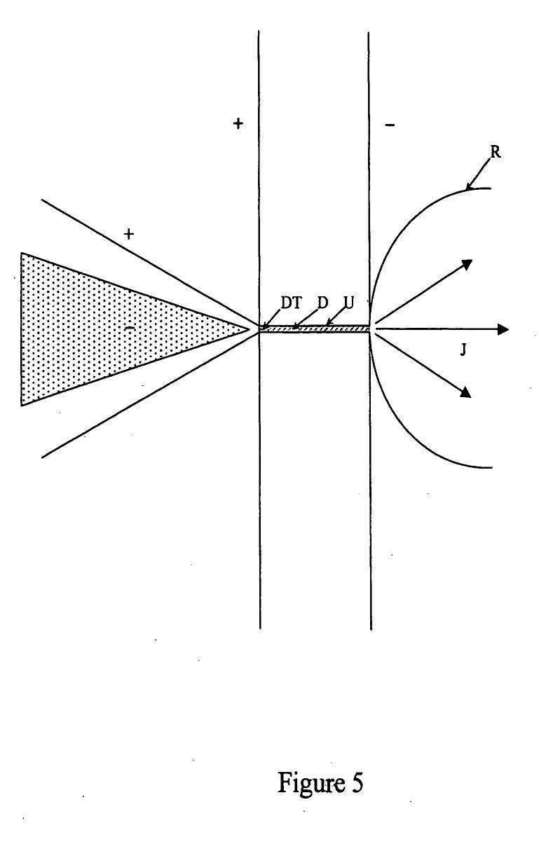

By deforming the outer transmission line into two concentric discs from a circular stripline, while leaving unchanged the inner high voltage lower current transmission line, one arrives at the configuration shown in FIG. 4. It is especially well suited for the transmission of a large current through the high current lower voltage transmission line requiring a low impedance. As shown in FIG. 5, in a side-view, this configuration is also well suited for rocket propulsion. The impedance of a coaxial transmission line is

Z=60 log(b/a)[Ω] (1)

Where a is the radius of the inner, and b the radius of the outer conductor. In a magnetically insulated transmission line, the line impedance is matched to the current pulse passing through the line. For the inner transmission line we have I=3×10⁵ A, V=10⁷ V, requiring that Z≈30 Ω, keeping the ratio b/a constant along the tapered conical section of the transmission line.

For the outer transmission line I=10⁷ A, V=10⁶ V, and therefore Z=0.1 Ω. Such a small impedance is not possible with a single line, but is possible with several lines in parallel, or with a circular stripline shown in FIGS. 4 and 5.

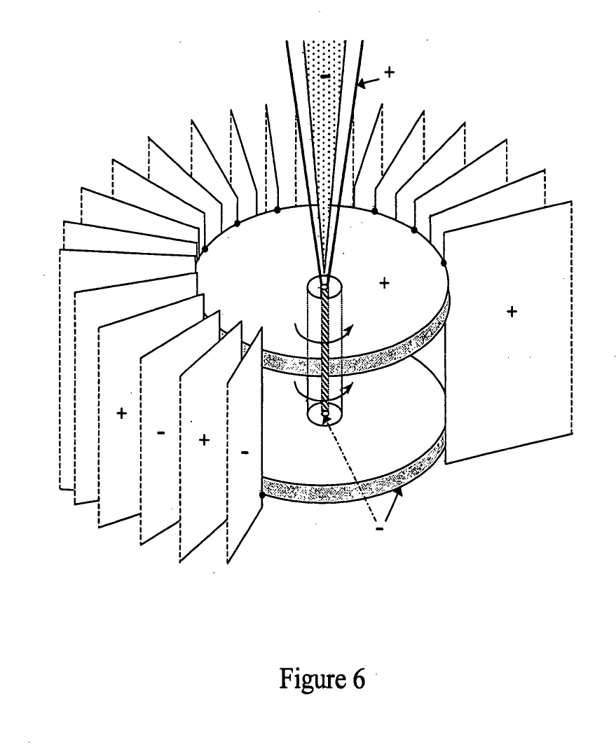

For the very large currents in the outer transmission line, the configuration shown in FIG. 6 might be advantageous. It uses a convoluted feed which can transport currents of up to ≈10⁸ A for as short as ≈10⁻⁸ sec as it was proposed by I. Smith, Proceedings of the International Topical Conference on Electron Beam Research and Technology, Nov. 3-6, 1975, Albuquerque, N. Mex., Vol. I, p. 472ff., and F. Winterberg, Nuclear Instruments and Methods, 136, 437 (1976). This configuration can also be seen as the core of a hypothetical thermonuclear microexplosion reactor, provided some means is added for the continuous replenishment of the liquid in the vortex, heated by the absorption of the 14 MeV neutrons from the DT fusion reaction. With a larger energy in the microexplosions, the hot liquid lithium might drive a magnetohydrodynamic generator not shown in FIG. 6.

### Compression and Confinement

As an example assume a solid DT cylinder with a radius r₀=10⁻² cm inside a thin metallic liner. With a current I₀=10⁷ A flowing over the liner, the magnetic field at the liner surface is H=2×10⁸ G, with the magnetic pressure H²/8π=1.6×10¹⁵ dyn/cm² acting on the DT. As for exploding wires the temperature of the thin metallic liner is at these energy densities determined by the Stefan-Boltzmann law in excess of ≈10⁶° K. By heat conduction the DT inside the liner will assume the same temperature. Then, by equating the pressure p=2nkT, of the hot DT plasma at T=4×10⁶° K for example, with the magnetic pressure H²/8π one finds that n≈30n₀, where n₀=5×10²² cm⁻³ is the particle number density of solid DT.

To confine the charged DT fusion reaction α-particles within the DT cylinder of radius r requires that

$$r \text{>>} {r}_{L} = \frac{a}{H} , a = 2.7 \times {10}^{5} [ G cm ] \qquad ( 2 )$$

Where r_{L} is the Larmor radius of the α-particles. With H=0.2I₀/r this implies that

I₀>>5a=1.35×10⁶ A (3)

### Independent of r, where

$$\frac{{r}_{L}}{r} = \frac{5 α}{{I}_{0}} \qquad ( 4 )$$

### For the example I₀=10⁷ A one has r_{L}/r=0.13

### Ignition and Burn

In three dimensions thermonuclear burn requires that ρr≧1 g/cm², where ρ is the density of the DT fuel. While in three dimensions only the fraction ⅙ of the charged fusion products goes into the direction of the burn wave, this fraction is ½, or three times larger, in a one dimensional burn wave in the presence of a strong azimuthal magnetic field, where the α-particles are radially confined. This changes the condition ρr≧1 g/cm² into ρz≧(⅓) g/cm². With the 30 fold compression of the DT making its density equal to ρ≈3 g/cm³, then requires that z≧0.1 cm. For ignition a cylinder of this length and radius r containing 2nπr²z=2n₀πr₀²z≈3×10¹⁸ DT nuclei and electrons musty be heated to T≈10⁸° K. This requires an energy equal to 3×10¹⁰ erg=3 kJ, to be delivered by the relativistic electron beam in a time shorter than the bremsstrahlungs loss time

τ_{R}=3×10¹¹\sqrt{T}/n[sec] (5)

which for T=10⁸° K and n=30n₀ is τ_{R}=3×10⁻⁹ sec. This condition can be met by a 10⁷ V, 3×10⁵ A electron beam emitted just at the Alfvén limit and lasting for ≈10⁻⁹ sec.

In addition, the power flux of the electron beam:

φᵢₙ=IV (6)

must be balanced by the power flux of the DT ablated from the end of the DT cylinder:

$${φ}_{out} = 2 n \frac{{Mv}^{2}}{2} \frac{v}{6} π {r}^{2} = \frac{1}{6} {nMv}^{3} π {r}^{2} \qquad ( 7 )$$

where ν is the nondirectional ablation velocity, with the fraction ⅙ going in one direction, M the mass of the DT nuclei and r the radius of the DT cylinder. With nr²=n₀r₀² one has

$${φ}_{out} = \frac{1}{6} ρ {v}^{3} π {r}_{0}^{2} \qquad ( 8 )$$

where ρ=n₀M=0.21 g/cm³ is the density of solid DT. Equating φᵢₙ with φₒᵤₜ leads to

$$\frac{IV}{π {r}_{0}^{2}} = \frac{1}{6} ρ {v}^{3} \qquad ( 9 )$$

### For the example I=3×10⁵ A, V=10⁷ V and r₀=10⁻² cm one finds that IV/πr₀²≈10²³ erg/cm²s, and one finds that

T=Mν²/3k≈10⁸° K (10)

about equal the ignition temperature of the DT reaction.

The stopping length of the electron beam in solid DT by the two-stream instability is [6]:

$$λ = \frac{1.4 c γ}{{ω}_{ρ} {ɛ}^{1 / 3}} \qquad ( 11 )$$

where

$$ɛ = {n}_{b} / {n}_{0} , {ω}_{p} = \sqrt{4 π {n}_{0} {e}^{2} / {m}_{0}} , γ = {( 1 - {v}^{2} / {c}^{2} )}^{- 1 / 2}$$

where with n_{b} the electron number density in the electron beam, and with the relativistic factor γ taking into account the longitudinal electron mass m=γ³m₀. At a beam radius equal to r₀=10⁻² cm, and a beam current of I=3×10⁵ A, one finds that n_{b}≈10¹⁷ cm⁻³. For 10 MeV electrons γ≈20 and one finds that λ≈10⁻² cm. By comparison, the classical stopping power length of relativistic electrons in matter of density ρ is

$${λ}^{*} = \frac{1}{ρ} ( 0.543 {E}_{0} - 0.16 ) [ cm ] \qquad ( 12 )$$

where E₀ is the electron energy in MeV and ρ≈6.3 g/cm³ the density of 30 fold compressed DT. For E₀=10 MeV, one finds that λ=0.7 cm, still short enough to satisfy the ρz≧(⅓) g/cm² condition for propagating burn with an ignition energy less than 100 kJ.

The rapid dissipation of the electron beam energy leads in the presence of a strong transverse magnetic field to a collisionless shock with a thickness of the order of the plasma ion gyroradius, which for a DT plasma at ≈10⁸° K and a magnetic field of ≈10⁸ G is of the order ≈10⁻⁴ cm. Following ignition, the collisionless shock goes over into a thermonuclear detonation wave propagating with supersonic speed down the DT cylinder.

### The Relativistic Electron Beam Emitted From the Cathode Tip of the High Voltage Line

The current density of the field emitted electrons is [8]

j=1.55×10⁻⁸ (E²/W)exp(−6.9×10⁷ W^{3/2}/E)[A/cm²] (13)

where E is the electric filed at the cathode in V/cm and W the work function in eV. For a semispherical cathode tip of radius r one has E≅V/r, where V is the electric potential of the cathode. If W=4.4 eV as for tungsten, one has for the total current emitted from a semispherical surface area 2πr²:

I=2.2×10⁻⁶V²exp(−6.4×10⁸r/V)[A] (14)

For the example V=10⁷ V, r=0.1 cm, one finds I=3×10⁵ A, about equal the Alfvén current. The magnetic field by this current at the cathode tip of radius r=0.1 cm is H=7×10⁵ G, with a magnetic pressure H²/8π≈2×10¹⁰ dyn/cm² at the tensile strength limit of the cathode material.

### Beam Focusing

The electron beam emitted at a radius from the cathode tip of the high voltage line at a radius r=0.1 cm must be focused down to the radius r₁≈10⁻³ cm of the 30 fold compressed DT cylinder. The maximum possible focusing is determined by the Liouville theorem which says that

γm₀cr₁=m₀ν₀r (15)

where γm₀ is the transverse electron mass and ν₀≈2×10⁸ cm/s the electron velocity at the ≈10⁵° K Fermi temperature of the degenerate electron gas in the field emission cathode. One thus obtains

$$\frac{{r}_{1}}{r} = \frac{{10}^{- 2}}{γ} \qquad ( 16 )$$

for γ=20, r₁/r≈5×10⁻⁴, which is more than what is needed, and with good beam focusing a beam radius less than 10⁻² cm seems feasible.

To keep the beam in the center of the diode gap its repulsion by magnetic image currents in the return current conductor may suffice.

With partial space charge neutralization the radial electric field in the beam is

Eᵣ=(1−ƒ)2πn_{b}er, (17)

where ƒ=n/n₀ with n the number density of a singly ionized low density background plasma. The azimuthal magnetic field inside the beam is

H=2πneβr (18)

hence

$${E}_{r} = ( 1 - f ) \frac{{H}_{φ}}{β} \qquad ( 19 )$$

### The radial self force acting on the beam electrons therefore is

$$\begin{matrix}F = e ( {E}_{r} - β {H}_{φ} ) \\ = \frac{e}{β} ( \frac{1}{{y}^{2}} - f ) {H}_{φ}\end{matrix} \qquad ( 20 )$$

and if an axial field H_{z} is present the force is

$$F = \frac{e}{β} ( \frac{1}{{γ}^{2}} - f ) {H}_{φ} + e \frac{{v}_{φ}}{c} {H}_{ z} \qquad ( 21 )$$

which for β≈1, and ν_{φ}/c=1 becomes

$$F = e [ ( \frac{1}{{γ}^{2}} - f ) {H}_{φ} + {H}_{z} ] \qquad ( 22 )$$

### The force becomes attractive and the bean self-focusing if F<0, or if

$$( \frac{1}{{γ}^{2}} - f ) {H}_{φ} + {H}_{z} < 0 \qquad ( 23 )$$

Without an applied external field, i.e. H_{z}=0, this happens if

$$\frac{n}{{n}_{b}} = f > \frac{1}{{γ}^{2}} \qquad ( 24 )$$

For the example γ=20, n_{b}=10¹⁷ cm⁻³, this means that n>2.5×10¹⁴ cm⁻³ which is a low density background plasma. Without a background plasma, i.e. ƒ=0, beam focusing requires that

$$\frac{{H}_{z}}{{H}_{φ}} > \frac{1}{{γ}^{2}} \qquad ( 25 )$$

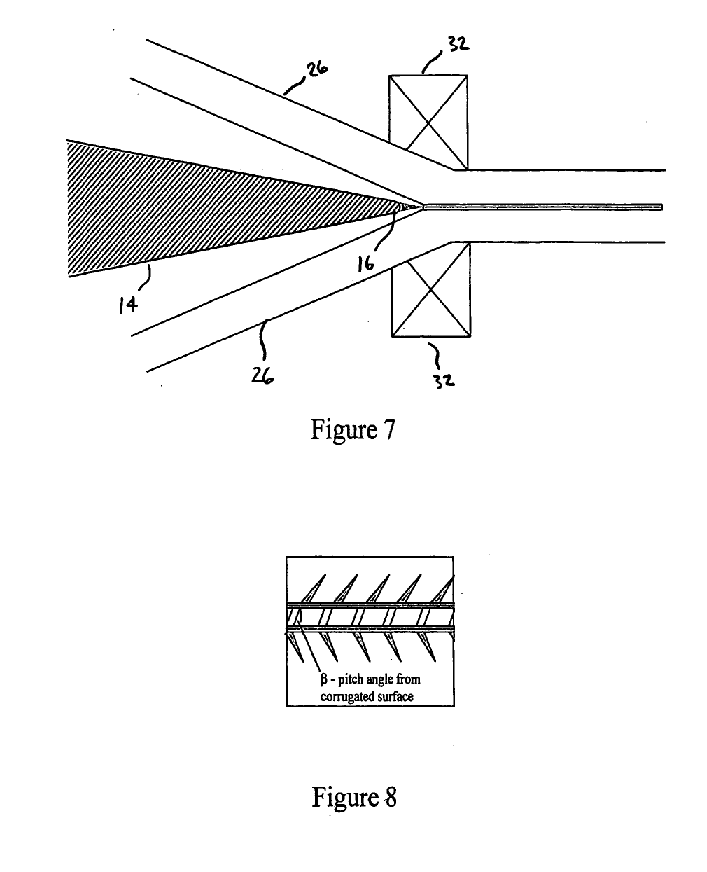

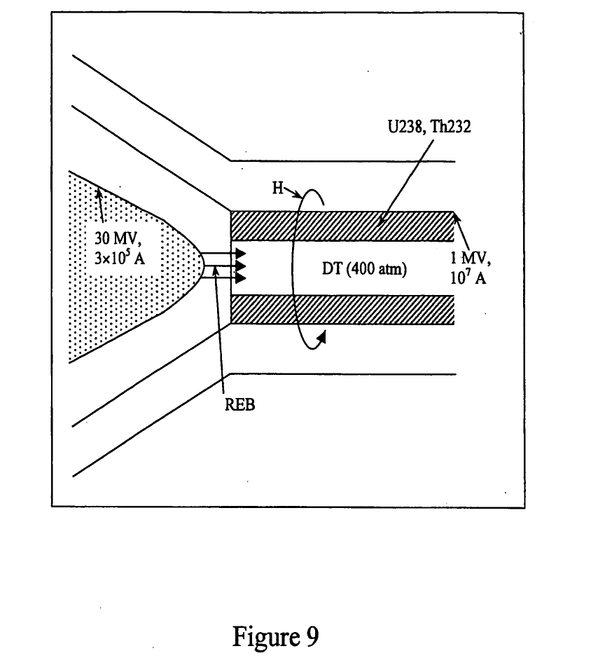

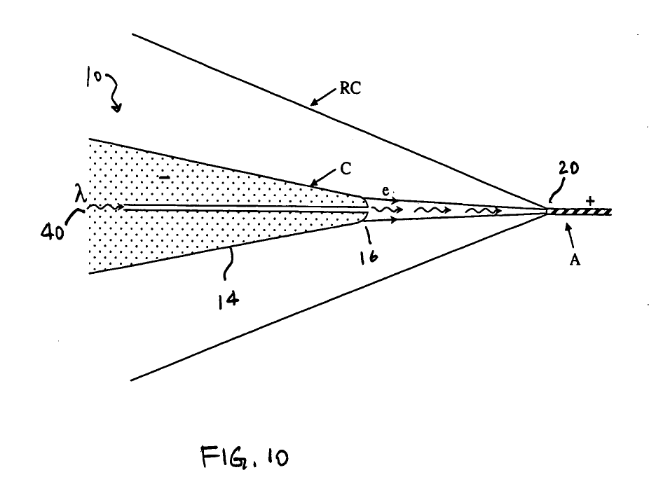

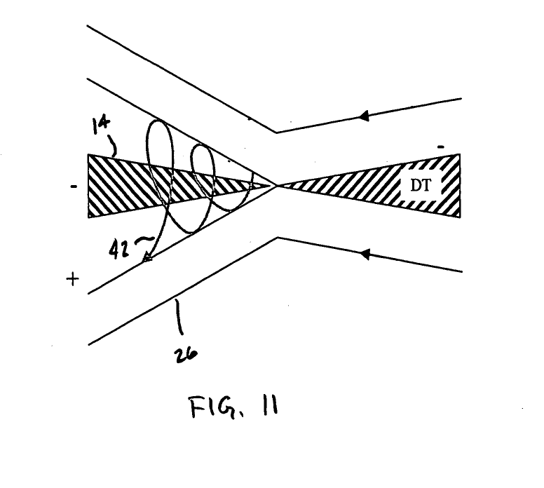

If the beam with a current I=3×10⁵ A is focused down to r≈2×10⁻³ cm, corresponding to a 30 fold compression of the DT cylinder, one has H_{φ}=3×10⁷ G, and with γ=20, one needs H_{z}=10⁵ G, which is feasible. To focus the beam onto the DT cylinder one may use in combination with a low density background plasma a magnetic mirror field produced by a magnetic solenoid as shown in FIG. 7.

Much less beam focusing appears sufficient with the fusion-fission concept, but alternatively also by axially increasing the DT density along the cylinder from the point of ignition, with an ignited lower density DT at a larger diameter of the cylinder, igniting higher density DT at a smaller radius.

### Thermonuclear Yield and Gain

If the DT cylinder has a length l, it contains

N_{DT}=(½)n₀πr₀²l=0.8×10¹⁹

### DT pairs each pair releasing ε_{ƒ}=17.6 MeV=2.8×10⁻⁵ erg, in total the output energy

Eₒᵤₜ=N_{DT}ε_{ƒ}=2×10¹⁴lerg

### With the input energy determined by the high current lower pulse, I₀=10⁷ A, V₀=10⁶ V, lasting τ=10⁻⁸ sec, one has

Eᵢₙ=10⁵ J=10¹² erg

and hence for the gain

$$G = \frac{{E}_{out}}{{E}_{i n}} = 200 l$$

A gain G=10³, for example, would require that l=5 cm. Such a large gain, of course, is possible only if nτ≧10¹⁴ cm⁻³s, according to the Lawson breakeven criterion. For n=30n₀=1.5×10²⁴ cm⁻³ and τ=10⁻⁸ s one has nτ=1.5×10¹⁶ cm⁻³s, or about 100 times larger than the Lawson value.

Of the yield Eₒᵤₜ=10¹⁵ erg=100 MJ, 80% or 80 MJ are released into neutrons, with only 20 MJ released into α-particles. The 80 MJ is released in the liquid lithium vortex over the neutron slowing down length less than 1 meter, while the remaining 20 MJ in charged fusion products can be magnetohydrodynamically converted into an electromagnetic pulse.

The evaporation of a liquid requires ≈10¹⁰ erg/cm³. Therefore, an energy input of 8×10¹⁴ erg would require a liquid lithium volume of a little more than ( 1/10)m³, to prevent the lithium from evaporating. With a DT cylinder 5-cm long, the length of the liquid lithium vortex would have to be much longer to absorb over a volume of ≈0.1 m³ all the DT fusion neutrons. However, with the large nτ value of ≈10¹⁶ cm⁻³s, about equal the Lawson value for the deuterium-deuterium (DD) reaction, this opens the intriguing possibility to fill only at its point of ignition a fraction of the cylinder with DT, with the rest filled with liquid deuterium, with DT acting as a fuse to ignite the DD reaction. With the much smaller amount of energy released into neutrons by the DD reaction, this not only would reduce the heating of the lithium vortex, but more importantly, open the prospect for DD burn.

### Stability

As for the linear z-pinch discharge, the DT-containing liner is subject to the same magnetohydrodynamic m=0 and m=1 instabilities. Stabilization can be achieved by axial and rotational shear flow. For DT embedded inside a metallic liner, axial and rotational shear flow can be induced by a corrugated liner surface as shown in FIG. 8. The shear flow is here generated during the magnetic liner implosion by supersonic jets emitted from the corrugated liner surface.

### Concurrent Burn of Deuterium-Tritium with Uranium 238 or Thorium 232

Apart from the prospect of DD fusion burn, the proposed concept can even be used for the concurrent burn of DT with natural uranium (U238), thorium (Th232) or even boron (B10). The coupling of fission and fusion reactions in a fissile pellet surrounded by a DT blanket for the release of nuclear energy, both from fission and fusion, was proposed many years ago, as was the autocatalytic fusion-fission implosion of a DT plasma surrounded by a blanket of U238, Th232 or B10. In both cases the coupling of the fission and fusion reaction becomes important even at temperatures less than the DT ignition temperature, and at densities less than solid state densities, because a large number of fusion neutrons are there already released at a sufficiently high rate to increase the temperature in the blanket by fast fission reactions of the 14 MeV-DT fusion neutrons.

Consider here DT gas under high pressure inside a thin cylindrical liner of length l, and radius r, surrounded by a blanket of thickness δ, consisting of U238 or Th232 (see FIG. 8). The DT fusion reaction rate in the DT cylinder per unit volume is given by

$$\frac{\partial n}{\partial t} = - \frac{{n}^{2}}{4} 〈 σ v 〉 \qquad ( 26 )$$

where n is the DT number density and <σν> the fusion reaction cross section velocity product averaged over a Maxwellian.

From (26) one obtains for the neutron flux at the surface of the cylinder of radius r:

φ=(½πr)∫₀^{r}(n²/4)<σν>2πr′dr′=(r/8)<σv>n² (27)

The fission reaction mean free path of the DT fusion neutrons in the blanket is Σ_{ƒ}⁻¹, where Σ_{ƒ}=n_{ƒ}σ_{ƒ} is the macroscopic fast fission cross section of the blanket, with n_{ƒ} the atomic number density of the blanket and of the fast fission cross section. For solid uranium (or thorium) n_{ƒ}=4×10²² cm⁻³ and σ_{ƒ}=2×10⁻²⁴ cm², whereby σ_{ƒ}⁻¹≈10 cm. If δ<<Σ_{ƒ}⁻¹, the neutron flux φ nearly constant throughout the blanket. For such a thin blanket, the energy released per unit volume and time τ is

ε=Σ_{ƒ}φ(ε_{ƒ}+ε₀)τ (28)

where ε_{ƒ} the energy per fission and ε₀ the kinetic energy of the DT fusion neutrons. The time τ is the inertial confinement time of the blanket, which by order of magnitude is

τ=δ/a (29)

where α≅\sqrt{p/ρ} is the velocity of sound in the hot blanket of density ρ. The justification of eq. (28) can perhaps be better seen by writing it with help of eq. (29) follows:

$$ɛ = φ ( {ɛ}_{f} + {ɛ}_{0} ) ( \frac{δ}{L} ) \frac{1}{a} . \qquad ( 28 a )$$

where L=1/Σ_{ƒ} is the fusion reaction length in the blanket with the fraction (δ/L) of neutrons passing through the blanket making a fission. Without the division by the velocity of sound α, eq. (28a) would be the energy flux density in the blanket. Since by order of magnitude ρ≈ε, one has

τ=δ\sqrt{ρ/ε} (30)

and one obtains from (28)

ε=[Σ_{ƒ}φ(ε_{ƒ}+ε₀)δ]^{2/3}ρ^{1/3} (31)

### By inserting φ from (27) this becomes

ε=(¼)[Σ_{ƒ}(ε_{ƒ}+ε₀)<σv>n²rδ]^{2/3}ρ^{1/3} (b 32)

If ε>2nkT, where 2nkT is the DT plasma pressure, the blanket begins to implode the DT plasma, accelerating the coupled fusion-fission reaction. With the help of (32) the condition that ε>2nkT can be written as

$$n ( r {δ}^{2} ) > \frac{{( kT )}^{3}}{{〈 σ v 〉}^{2}} \frac{5 / 2}{{[ {\sum }_{f} ( {ɛ}_{f} + {ɛ}_{0} ) ]}^{2} ρ} \qquad ( 33 )$$

### The smallest possible density of the DT plasma to satisfy this inequality is given by the minimum of (kT)³/<σν>² which is at T≅15 keV, where (kT)³/<σν>²≅2×10⁸erg³ s²/cm⁶.

### We therefore have for the minimum

n(rδ)²|ₘᵢₙ≈10¹¹[Σ_{ƒ}(ε_{ƒ}+ε₀)]⁻²ρ⁻¹[cm] (34)

For natural uranium (and thorium), one has Σ_{ƒ}≅0.8×10⁻¹ cm, ε_{ƒ}+ε₀≅3×10⁻⁴ erg, and σ=18 g/cm³. For these numbers one finds that n(rδ)²|ₘᵢₙ≅10⁻¹⁹ cm. With n=10²² cm⁻³, realized for DT gas at room temperature compressed to 400 atm, one has (rδ)²=10⁻³ cm⁴. Choosing δ=2r (equal thickness of blanket and core), one finds that r=0.13 cm. These numbers also apply for thorium. This example shows that less beam focusing is here required.

Also instructive is the magnitude of the pressure the blanket exerts on the DT plasma core. In a case where the DT plasma pressure is balanced by the pressure of the blanket, the pressure is p=2nkT at T=15 keV=2.4×10⁻⁸ erg. With n(rδ)²=10¹⁹ cm, one finds that

p=5×10¹¹ (rδ)⁻²[dyn/cm²]

### For (rδ)²=10⁻³ cm⁴, one finds that p=5×10¹⁴ dyn/cm².

To let the magnetic field diffuse through the blanket and to confine the charged fusion products to within the DT cylinder, requires a semi- or non-conducting blanket. This could be done by doping a non-conducting medium with metallic uranium or thorium.

As before, the heating is done by a relativistic electron beam through the combined action of the electrostatic two-stream instability and the strong magnetic field, with the relativistic electron beam coming from the inner transmission line and the magnetic field from the current flowing through the outer line. For the ignition (of the magnetic field assisted thermonuclear burn wave) a volume of the order πr²×2r has to be heated to 15 keV, which for the example of a dense DT plasma with the number density n=10²² cm⁻³ surrounded by a uranium blanket is about 10⁶ J. With the radiation loss time (at 15 keV and n=10²² cm⁻³) of the order 10⁻⁷ s, this energy could be supplied by a 30 MV, 300 kA relativistic electron beam.

Because part of the neutrons released behind the detonation front react with the uranium, thorium, or boron in the blanket ahead of the front, the pressure there created will implode the DT, accelerating the reaction rate of this autocatalytic detonation wave burn.

The division of the two tasks, compression and ignition by two Marx generators, one with a large current and large energy for compression, and one with a large voltage but much smaller energy for ignition, resembles the laser fast ignition concept, where one large lower power laser is used for compression and a second much smaller high power laser for ignition. And in both cases DD burn is possible with a DT trigger. By comparison, the competing electric pulse power concept presented here has three crucial advantages. First, electric pulse power is by about two orders of magnitude less expensive than lasers. In addition, because of the much higher efficiency electric pulse power has in comparison to lasers, much smaller yields can here be tolerated, more suitable for confining the blast of the microexplosions. Finally, because of the linear geometry, possible through the presence of a multimegagauss magnetic fields surrounding the cylindrical fusion target, the input energy for compression and ignition can conceivably be reduced to ≈10⁵ J.

In comparison to the multiple wire implosion approach pursued by the Sandia National Laboratories, the much smaller yield makes it much easier to replace the field emission electrode following each microexplosion. This is especially true, if the needle-like field emission electrode is formed by a liquid jet.

The two most important outstanding questions are the focusing of the relativistic electron beam to the required small diameter, and the heating by the electrostatic two-stream instability of the dense magnetized DT plasma. Fortunately, these questions can be answered experimentally with existing equipment and with modest expenditures.

The invention does not exclude the emission of an ion beam from the end of the inner transmission line by reversing the electrical polarity of both transmission lines. Furthermore, that there can be two inner transmission lines, which in the drawings would be on the right side of the drawings, positioned inside the outer transmission line.

The invention does also not exclude other high voltage-high current generators, other than high voltage Marx generators.

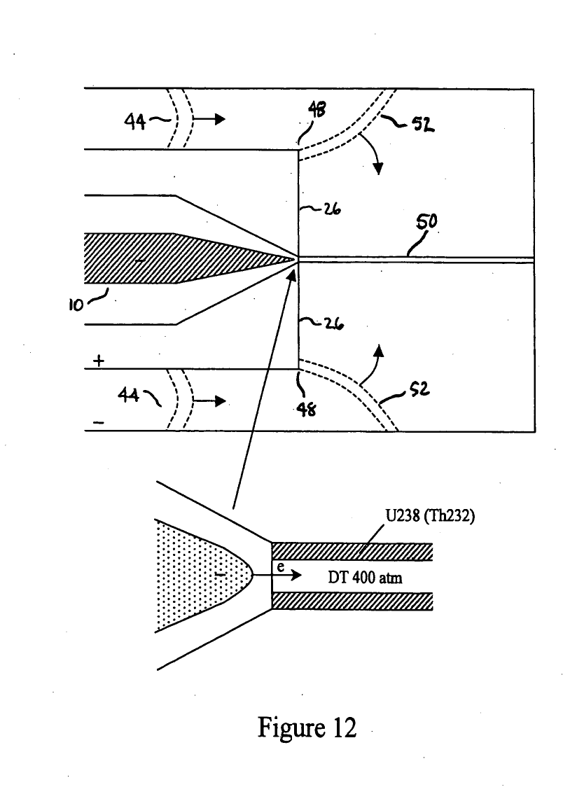

Another embodiment of the invention is shown in FIG. 10, to which attention is now drawn. FIG. 10 is a diagram showing a portion of an apparatus like that of FIG. 1, but including an axial bore 40 formed through the inner transmission line 10 through which a low-power laser beam may be directed through the tip 16 of the cone 14 of the first transmission line to the tip 20 of the DT cone or cylinder. The laser radiation forms an ionization trail for the electron beam to the DT cone or cylinder.

Referring now to FIG. 11, a diagram illustrates a variation of the inner transmission line 10 including, for example, a spiral groove 42 formed in the inner conductor of the outer transmission line 26 to increase the breakdown voltage of the inner transmission line by magnetic insulation. The current flowing along this feature induces a magnetic field that helps confine the charge flowing through cone portion 14 of the inner transmission line 10.

Referring now to FIG. 12, a diagram shows another variation of the present invention in which the inner conductor 26 of the outer transmission line is formed in a cylindrical shape around the inner transmission line 10. A plasma sheet 44 is moving to the right between the inner surface of outer transmission line conductor 26 and a cylindrical wall 46 defining an outer wall. The plasma 44 moves to the right in the direction of the arrows. When it reaches the edge 48 of the outer conductor 26, the plasma sheet collapses radially onto the DT cylinder 50 as shown diagrammatically at reference numerals 52, concentrating the current onto DT cylinder 50. As in other embodiments, the DT cylinder may be clad with U238, Th232, or B10.

While the invention has been described with reference to exemplary embodiments, it will be understood by those skilled in the art that various changes may be made and equivalents may be substituted for elements thereof without departing from the scope of the invention.

What is claimed is:

1. An apparatus for generating thermonuclear microexplosions comprising:
a first pulsed high-voltage source configured for transmission of a first high-voltage pulse at a first high current;
a second pulsed high voltage source configured for transmission of a second high-voltage pulse at a potential higher than that of said first high-voltage pulse at a second high current having a magnitude less than that of said first high current;
an inner transmission line in electrical contact with said first pulsed high-voltage source, said inner transmission line having a tapered end;
an outer transmission line disposed over said inner line and in electrical contact with said first pulsed high-voltage source;
a deuterium-tritium mixture disposed between said inner transmission line and said outer transmission line, said deuterium-tritium mixture having a tapered end spaced apart from said tapered end of said inner transmission line.

2. The apparatus of claim 1 further comprising a liquid lithium vortex forming a core, said deuterium-tritium mixture being disposed inside said core.

3. The apparatus of claim 1 wherein said deuterium-tritium mixture is formed into one of a long thin cylinder and a cone.

4. The apparatus of claim 1 further comprising a blanket of at least one of a solid U238, a solid Th232 and a solid B10 disposed over said deuterium-tritium mixture.

5. The apparatus of claim 1 wherein said inner line and said outer line are concentrically nested and magnetically insulated having a common focus location.

6. The apparatus of claim 5 wherein said focus location includes said inner line having a smallest diameter.

7. The apparatus of claim 1 wherein said deuterium-tritium mixture is encased in a helically corrugated metallic liner.

8. The apparatus of claim 1 wherein said inner transmission line has an axial bore formed therethrough and further including a laser optically coupled to an end of said deuterium-tritium mixture.
